(19) United States
(12) Patent Application Publication
(10) Pub. No.: US 2023/0407088 A1
(43) Pub. Date: Dec. 21, 2023

(54) POLYAMIDE RESIN COMPOSITION

(71) Applicant: TOYOBO MC Corporation, Osaka (JP)

(72) Inventors: Nobuhiro YOSHIMURA, Shiga (JP); Ryo UMEKI, Shiga (JP); Yoshitaka AYUZAWA, Shiga (JP)

(73) Assignee: TOYOBO MC Corporation, Osaka (JP)

(21) Appl. No.: 18/265,077

(22) PCT Filed: Nov. 26, 2021
(86) PCT No.: PCT/JP2021/043426

§ 371 Date: Jun. 2, 2023

(30) Foreign Application Priority Data
Dec. 7, 2020 (JP) 2020-202926

(51) Int. Cl. C08L 77/06; C08L 77/02; C08K 7/14; C08K 3/32; C08J 5/04

(52) U.S. Cl. CPC C08L 77/06; C08L 77/02; C08L 2205/025; C08K 3/32; C08J 5/043; C08K 7/14

(57) ABSTRACT

[PROBLEM] To provide a polyamide resin composition capable of stably providing a molded article which is less likely to be affected by variations in production conditions, and has high rigidity, and good appearance. [SOLUTION] A polyamide resin composition including 0 to 3 parts by mass of a metal hypophosphite (D) with respect to a total of 100 parts by mass of 20 to 60 parts by mass of an aliphatic polyamide resin (A), 5 to 20 parts by mass of a polyamide MXD6 resin (B), and 30 to 59 parts by mass of an inorganic reinforcing material (C), wherein the polyamide resin composition has an MFR of 3 to 60 g/10 min when measured under conditions of a load of 2.16 kg and 275° C.

### TECHNICAL FIELD

The present invention relates to a polyamide resin composition, and more particularly to a polyamide resin composition which contains a high filling amount of a reinforcing fiber and is capable of providing a molded article having high strength, high rigidity and excellent appearance.

### BACKGROUND ART

In general, aliphatic polyamide resins typified by polyamide 6 and polyamide 66 have excellent mechanical strength, heat resistance, impact resistance, and chemical resistance, and are widely used for automobile parts, electrical parts, electronic parts, and household goods and the like. In particular, it is known that a fiber-reinforced polyamide resin composition to which an inorganic reinforcing material represented by glass fiber is added has significantly improved rigidity, strength, and heat resistance and the like, and the fiber-reinforced polyamide resin composition contains a large amount of reinforcing material such as glass fiber (Patent Documents 1 and 2 and the like).

However, when a large amount of reinforcing material such as glass fiber is added, the appearance or the like of a molded article is extremely deteriorated, and the commercial value is significantly impaired in many cases. Patent Documents 1 and 2 propose the use of a polyamide resin having a low viscosity, but the appearance of the molded article is not satisfactory. Therefore, Patent Document 3 proposes a method of using an amorphous semi-aromatic polyamide resin and a specific elastomer in combination in addition to an aliphatic polyamide resin in order to improve the appearance of a molded article (Patent Document 3).

This method certainly improves the appearance, but the method has drawbacks that the rigidity and heat resistance of the molded article are lowered, and has problems that the molded article is easily affected by variations in production conditions, the producing stability is difficult, and stable molded article characteristics are difficult to obtain.

### PRIOR ART DOCUMENTS

### Patent Document

Patent Document 1: JP-A-06-313045
Patent Document 2: JP-A-2007-112915
Patent Document 3: JP-A-2009-215534

### SUMMARY OF THE INVENTION

### Problems to be Solved by the Invention

The present invention is intended to solve the above-mentioned problems, and an object of the present invention is to provide a polyamide resin composition capable of stably providing a molded article which is less likely to be affected by variations in production conditions, and has high strength, high rigidity, good appearance, and excellent high-temperature rigidity while having a high filling amount of a reinforcing fiber.

In view of the fact that a molded article having good appearance cannot be stably obtained in some cases when different polyamide resins such as an amorphous polyamide resin are mixed and used in a crystalline aliphatic polyamide resin for improving the appearance, the present inventors have intensively studied the cause thereof. As a result, the present inventors have found that the cause depends on the fact that the progress level of an amide exchange reaction between polyamides is apt to vary when the production conditions vary. Therefore, the present inventors have conceived that if the amide exchange reaction can be advanced to reach a metastable polymer state at an early stage, the reaction is less likely to be affected by variations in production conditions, and have reached the present invention.

### Means for Solving the Problems

That is, the present invention is as follows.

(1) A polyamide resin composition including 0 to 3 parts by mass of a metal hypophosphite (D) with respect to a total of 100 parts by mass of 20 to 60 parts by mass of an aliphatic polyamide resin (A), 5 to 20 parts by mass of a polyamide MXD6 resin (B), and 30 to 59 parts by mass of an inorganic reinforcing material (C), wherein the polyamide resin composition has an MFR of 3 to 60 g/10 min when measured under conditions of a load of 2.16 kg and 275° C.

(2) The polyamide resin composition of (1), wherein a cooling crystallization temperature of the polyamide resin composition is 160 to 190° C.

(3) The polyamide resin composition of (1) or (2), wherein 0.001 to 3 parts by mass of the metal hypophosphite (D) is contained with respect to the total of 100 parts by mass of (A), (B) and (C).

(4) The polyamide resin composition of any one of (1) to (3), wherein 40 to 59 parts by mass of the inorganic reinforcing material (C) in the polyamide resin composition is contained with respect to the total of 100 parts by mass of (A), (B) and (C).

(5) The polyamide resin composition of any one of (1) to (4), wherein the inorganic reinforcing material (C) is glass fiber.

(6) The polyamide resin composition of any one of (1) to (5), wherein the polyamide resin composition has an MFR of 4 to 25 g/10 min when measured under conditions of a load of 2.16 kg and 275° C.

### Effect of the Invention

A polyamide resin composition of the present invention can stably provide a molded article which is less likely to be affected by variations in production conditions, and has high strength, high rigidity, good appearance, and excellent high temperature rigidity.

### MODE FOR CARRYING OUT THE INVENTION

Hereinafter, the present invention will be specifically described.

An aliphatic polyamide resin (A) in the present invention preferably has an acid amide bond (—CONH—) in the molecule and has a crystal melting point. Specific examples thereof include, but are not limited to, polymers such as polycaproamide (polyamide 6), polyhexamethylene adipamide (polyamide 66), polytetramethylene adipamide (polyamide 46), polyhexamethylene sebacamide (polyamide 610), polyhexamethylene dodecamide (polyamide 612), polylauryl lactam (polyamide 12), and poly-11-aminoundecanoic acid (polyamide 11), and copolymers and blends thereof. In the present invention, preferable examples of the aliphatic polyamide resin (A) include polyamide 6, polyamide 66, and a mixture of polyamide 6 and polyamide 66, and polyamide 6 is particularly preferable.

The relative viscosity (96% sulfuric acid, by measurement at a polyamide resin concentration of 1 g/di) of the aliphatic polyamide resin (A) is preferably in the range of 1.8 to 3.5, and more preferably in the range of 2.0 to 3.2.

The blending ratio of the aliphatic polyamide resin (A) to the total of 100 parts by mass of the aliphatic polyamide resin (A), a polyamide MXD6 resin (B), and an inorganic reinforcing material (C) is 20 to 60 parts by mass, preferably 25 to 50 parts by mass, and more preferably 28 to 42 parts by mass.

When the blending ratio is less than. 20 parts by mass and more than 60 parts by mass, the effect of the present invention is less likely to be exhibited. In the present invention, the blending ratio is a content ratio in the polyamide resin composition as it is.

The polyamide MXD6 resin (B) in the present invention is a polyamide resin mainly composed of polymetaxylylene adipamide, and is a polycondensate of a diamine component in which at least 80 mol % of the diamine component is metaxylylenediamine and a dicarboxylic acid component in which at least 80 mol % of the dicarboxylic acid component is adipic acid. As the diamine component other than meta-xylylenediamine, para-xylylenediamine, tetramethylenediamine, or hexamethylenediamine or the like can be used as long as it is 20 mol % or less. As the dicarboxylic acid component other than adipic acid, an aliphatic dicarboxylic acid such as sebacic acid can be used as long as it is 20 mol % or less.

The relative viscosity (96% sulfuric acid, by measurement at a polyamide resin concentration of 1 g/dl) of the polyamide MXD6 resin (B) is preferably in the range of 1.5 to 4.0, and more preferably in the range of 1.8 to 3.0.

The blending ratio of the polyamide MXD6 resin (B) to the total of 100 parts by mass of the aliphatic polyamide resin (A), the polyamide MXD6 resin (B) and the inorganic reinforcing material (C) is 5 to 20 parts by mass, preferably 10 to 20 parts by mass, and more preferably 10 to 17 parts by mass. When the content is in this range, the molded article has excellent moldability, appearance, and heat resistance. When the content is less than 5 parts by mass and more than 20 parts by mass, the effect of the present invention is less likely to be exhibited.

Regarding the blending ratio of the aliphatic polyamide resin (A) and the polyamide MXD6 resin (B), the blending ratio of the polyamide MXD6 resin (B) to 100 parts by mass of the aliphatic polyamide resin (A) is preferably 10 to 90 parts by mass, more preferably 10 to 70 parts by mass, still more preferably 10 to 55 parts by mass, and yet still more preferably 15 to 45 parts by mass. When the blending ratio is less than 10 parts by mass, it is difficult to control the crystallization temperature, and when the blending ratio is more than 90 parts by mass, the glass transition temperature is high, so that it is difficult to obtain good appearance unless the mold temperature is increased.

The inorganic reinforcing material (C) of the present invention most effectively improves physical properties such as strength, rigidity, and heat resistance, specific examples thereof include fibrous materials composed of a glass fiber, a carbon fiber, an alumina fiber, a silicon carbide fiber, and a zirconia fiber and the like, whiskers composed of aluminum borate and potassium titanate and the like, needle-like wollastonite, and a milled fiber. In addition to these, fillers such as a glass bead, a glass flake, a glass balloon, silica, talc, kaolin, wollastonite, mica, alumina, hydrotalcite, montmorillonite, graphite, a carbon nanotube, fullerene, zinc oxide, indium oxide, tin oxide, iron oxide, titanium oxide, magnesium oxide, aluminum hydroxide, magnesium hydroxide, red phosphorus, calcium carbonate, potassium titanate, lead zirconate titanate, barium titanate, aluminum nitride, boron nitride, zinc borate, aluminum borate, barium sulfate, magnesium sulfate, and layered silicate subjected to an organic treatment for the purpose of delamination can also be used as the inorganic reinforcing material (C). Among these, a glass fiber and a carbon fiber and the like are preferably used, and a glass fiber is particularly preferable. These inorganic reinforcing materials (C) may be used singly or in combination of two or more kinds thereof.

When a fibrous reinforcing material is used as the inorganic reinforcing material (C), the inorganic reinforcing material (C) is preferably treated in advance with a coupling agent such as an organosilane-based compound, an organotitanium-based compound, an organoborane-based compound, or an epoxy-based compound. Particularly preferably, the inorganic reinforcing material (C) is likely to react with a carboxylic acid group and/or a carboxylic acid anhydride group. For example, a polyamide resin composition containing a glass fiber treated with a coupling agent is preferable because the polyamide resin composition provides a molded article having excellent mechanical characteristics and appearance characteristics. When the coupling agent is not treated, other fibrous reinforcing materials can also be added later and used.

When the glass fiber is used as the inorganic reinforcing material (C), a chopped strand cut to a fiber length of about 1 to 20 mm can be preferably used. The cross-sectional shape of the glass fiber that can be used is a circular cross-sectional shape or a non-circular cross-sectional shape. The glass fiber having a non-circular cross section also includes those having a substantially elliptical shape, a substantially oval shape, and a substantially cocoon shape in a cross section perpendicular to the length direction of a fiber length, and in this case, the ovality of the glass fiber is preferably 1.5 to 8. Here, the ovality is a ratio of a major axis to a minor axis. The major axis is a length of a long side of a rectangle having a minimum area and circumscribing a cross section perpendicular to the longitudinal direction of a glass fiber, and the minor axis is a length of a short side of the rectangle. The thickness of the glass fiber is not particularly limited, but the minor axis is about 1 to 20 μm, and the major axis is about 2 to 100 μm.

The glass fiber is preferably treated with a silane-based or titanate-based coupling agent, and particularly preferably treated with a silane-based coupling agent. Preferable examples of the silane-based coupling agent include γ-glycidoxypropyltrimethoxysilane, γ-glycidoxypropylmethyldiethoxysilane, β-(3,4-epoxycyclohexyl)ethyltrimethoxysilane, γ-anilinopropyitrimethoxysilane, γ-(2-aminoethyl)aminopropyltrimethoxysilane, γ-methacryloxypropyltrimethoxysilane, vinvltrimethoxysilane, and γ-mercaptopropyltrimethoxysilane. Particularly, γ-glycidoxypropyitrimethoxysilane, γ-anilinopropyltrimethoxysilane, γ-(2-aminoethyl)aminopropyltrimethoxysilane, and γ-methacryloxypropyltrimethoxysilane are preferable.

The blending ratio of the inorganic reinforcing material (C) to the total of 100 parts by mass of the aliphatic polyamide resin (A), the polyamide MXD6 resin (B) and the inorganic reinforcing material (C) is 30 to 59 parts by mass. The blending ratio is preferably 40 to 59 parts by mass, more preferably 45 to 59 parts by mass, and still more preferably 50 to 59 parts by mass. When the blending ratio is less than 30 parts by mass, rigidity may be insufficient, and when the blending ratio is more than 59 parts by mass, the molded article may have poor appearance. When the blending ratio of the inorganic reinforcing material (C) is 40 to 59 parts by mass, the balance between rigidity and molding appearance is particularly excellent, which is preferable.

The polyamide resin composition of the present invention preferably contains a metal hypophosphite (D). The metal hypophosphite (D) is a salt of hypophosphorous acid with Group 1, 2, 3, 4, 5, 6, 7, 8, 11, 12, or 13 element of the periodic table of elements and a metal such as tin or lead, and one kind or two or more kinds thereof may be used in combination. Among them, sodium hypophosphite (NaH₂PO₂) and calcium hypophosphite (Ca(H₂PO₂)₂) are preferable from the viewpoint that the effect of the present invention can be more remarkably achieved. The metal hypophosphite may be a hydrate, and examples thereof include sodium hypophosphite monohydrate (NaH₂PO₂·H₂O).

The blending amount of the metal hypophosphite (D) is preferably 0.001 to 3 parts by mass, more preferably 0.05 to 1.5 parts by mass, and still more preferably 0.08 to 0.8 parts by mass, with respect to the total of 100 parts by mass of the aliphatic polyamide resin (A), the polyamide MXD6 resin (B), and the inorganic reinforcing material (C). A molded article having excellent high strength, high rigidity, and high temperature rigidity can be obtained without blending the metal hypophosphite (0), but when the metal hypophosphite (D) is present within a specific range, the amide exchange reaction between the crystalline aliphatic polyamide resin and the polyamide MXD6 is promoted, which is preferable for stabilizing the characteristics of the resin composition.

The polyamide resin composition of the present invention has a melt flow rate (MFR) of 3 to 60 g/10 min, preferably 3 to 45 g/10 min, more preferably 4 to 25 g/10 min, still more preferably 5 to 20 g/10 min, and yet still more preferably 5 to 15/10 min, the melt flow rate measured under conditions of a load of 2.16 kg and 275° C. When the MFR is less than 3 g/10 min, fluidity may be insufficient in the case of a thin-walled molded article, and when the MFR exceeds 60 g/10 min, burrs tend to be easily generated in the molded article. This MFR can be achieved by using the polyamide resin composition having the above configuration.

When the polyamide resin composition of the present invention has an MFR of 4 to 25 g/10 min measured under conditions of a load of 2.16 kg and 275° C., the polyamide resin composition has excellent fluidity, which is preferable for obtaining a molded article having the effect of the present invention. This MFR can be achieved by adjusting the configuration of the polyamide resin composition.

In the polyamide resin composition of the present invention, a cooling crystallization temperature determined by DSC measurement at a temperature rising rate of 20° C./min in accordance with JIS K7121 is preferably 160 to 190° C., and more preferably 170 to 185° C. When the cooling crystallization temperature is lower than 160° C., the solidification speed may be slow and the molding cycle may be excessively long, and when the cooling crystallization temperature exceeds 190° C., the effect of improving the appearance of the molded article may be poor.

In addition to the above, it is also possible, as necessary, to further add a heat stabilizer, an antioxidant, an ultraviolet absorber, a light stabilizer, a plasticizer, a lubricant, a crystal nucleating agent, a release agent, an anti-static agent, a combination of a halogen-based flame retardant and antimony trioxide, various phosphoric acid-based flame retardants, melamine-based flame retardants, inorganic pigments, organic pigments, and dyes, or other kinds of polymers and the like within a known range, to the polyamide resin composition of the present invention. In the polyamide resin composition of the present invention, the total of the aliphatic polyamide resin (A), the polyamide NXD6 resin (B), the inorganic reinforcing material (C), and the metal hypophosphite (D) accounts for preferably 70% by mass or more, more preferably 80% by mass or more, and still more preferably 90% by mass or more.

A method for producing the polyamide resin composition of the present invention is not particularly limited as long as it is a method capable of melt-kneading, but a single-screw extruder, a twin-screw extruder, a kneader, a Banbury mixer, or a roll or the like can be used, and among them, a twin-screw extruder is preferably used. In the case of the twin-screw extruder, it is preferable that the above-described components (A) and (B), various additives, and the component (D) dissolved in water as necessary are preliminarily mixed with a tumbler or a Henschel mixer or the like, the preliminary mixture is supplied from a main feeder, the component (C) is supplied from a side feeder, and the components are melt-kneaded in a temperature range of 220 to 330° C. The polyamide resin composition melt-kneaded and discharged in a strand form into cooling water is pelletized by a pelletizer to a length of about 1 to 10 mm.

The polyamide resin composition of the present invention can be formed into a molded article by a known molding method. The molding method is not particularly specified, and can be suitably used in injection molding, blow molding, extrusion molding, foam molding, profile molding, calendar molding, and other various molding methods. Among them, injection molding is preferable. A molded article formed from the polyamide resin composition of the present invention has high rigidity and excellent appearance, and is therefore suitable for use as a metal substitute part in fields of automobiles, electric and electronic parts, and household products and the like. For example, it is suitable for a door mirror part and a breaker part and the like.

### EXAMPLES

Next, the present invention will be specifically described using Examples and Comparative Examples, but the present invention is not limited thereto. Note that measurement values and evaluations in Examples and the like were obtained by the following methods.

1. Measurement Method and Evaluation Method

(1) Relative Viscosity of Polyamide Resin (RV):

Measurement was performed using an Ubbelohde's viscometer at a polyamide resin concentration of 1 g/dl at 25° C. in a 96% by mass sulfuric acid solution.

(2) Cooling Crystallization Temperature (Tc2):

A DSC measuring device (EXSTAR6000 manufactured by Seiko Instruments Inc.) was used. The temperature was raised to 300° C. under a nitrogen flow at a temperature rising rate of 20° C./min, and maintained for 5 min. Then, a peak temperature of a crystallization peak observed when the temperature was dropped to 50° C. at a rate of 10° C./min was measured.

(3) Melt Flow Rate (MFR):

Measurement was performed in accordance with 1301133. Polyamide resin composition pellets dried until a moisture percentage became less than 0.1% by mass were used, and the melt flow rate of the pellets was measured under the conditions of a measurement temperature of 275° C. and a load of 2.16 kg.

(4) Flexural Strength, Flexural Modulus:

Measurement was performed in accordance with ISO-178.

(5) Charpy Impact Strength:

Measurement was performed in accordance with ISO-179-1 eA.

(6) Heat Deformation Temperature:

A deflection temperature under a load of 1.82 MPa was measured in accordance with JIS K 7191-2:2015.

(7) Method for Evaluating Appearance of Molded Article:

The mirror surface glossiness of the molded article was measured by the following method to evaluate the appearance of the molded article.

Using a mirror-finished mold having a size of 100 mm×100 mm×3 mm (thickness), a molded article was produced at a resin temperature of 280° C. and a mold temperature of ° C. Then, glossiness at an incident angle of 60 degrees was measured in accordance with JIS Z-8714. The higher the numerical value, the better the glossiness.

The measurement results of the glossiness were evaluated on the basis of the following criteria.

⊙: 97 or more

◯: 95 or more and less than 97

Δ: 90 or more and less than 95

X: less than 90

2. Raw Materials Used in Examples and Comparative Examples

### [Polyamide Resin]

A-1: Polyamide 6

“Glamide T-800” (RV2.6) manufactured by Toyobo Co., Ltd.

B-1: Polyamide MXD6

“Glamide T-600” (RV2.1) manufactured by Toyobo Co., Ltd.

B-2: Polyamide 6T6I

6T/6I=33/67 (mol %), Glivory G21. (RV2.0) manufactured by EMS

### [Inorganic Reinforcing Material]

C-1: Glass fiber

ECS03T-275H manufactured by Nippon Electric Glass Co., Ltd.

C-2: Talc

Talcan powder Ph manufactured by Hayashi Kasei Co., Ltd.

### [Metal Hypophosphite]

D-1: Sodium hypophosphite

### [Other Additives]

E-1: Magnesium stearate

E-2: Pigment

EPC-840 manufactured by Sumika Color Co., Ltd.

### Examples 1 to 13, Comparative Examples 1 to 4

Components excluding an inorganic reinforcing material was premixed in a tumbler so as to have compositions shown in Table 1 described later. The premixture was then supplied from a main feeder of a twin screw extruder (TEM-1008, L/D=40), and the inorganic reinforcing material was supplied from a side feeder. These were melt-kneaded (main barrel temperature: 270° C., discharge amount: 350 kg/hr or 450 kg/hr). A resin composition strand discharged into a water bath was pelletized with a strand cutter to obtain each resin composition pellet.

The obtained resin composition pellet was dried, and then evaluated by the above method. The results are shown in Table 1.

TABLE 1

| | | | Examples | | | | | | | | | |
|---|---|---|---|---|---|---|---|---|---|---|---|---|
| | | Unit | 1 | 2 | 3 | 4 | 5 | 6 | 7 | 8 | 9 | 10 |
| Blending | A-1: Polyamide 6 | Parts by mass | 32 | 32 | 32 | 32 | 32 | 35 | 35 | 30 | 30 | 39 |
| com- | B-1: Polyamide MXD6 | Parts by mass | 13 | 13 | 13 | 13 | 13 | 14 | 14 | 12 | 12 | 16 |
| position | B-2: Polyamide PA6T6I | Parts by mass | | | | | | | | | | |
| | C-1: Glass fiber | Parts by mass | 55 | 55 | 55 | 55 | 55 | 51 | 51 | 58 | 58 | 45 |
| | C-2: Talc | Parts by mass | | | | | | | | | | |
| | D-1: Sodium hypophosphite | Parts by mass | 0.1 | 0.1 | 0.5 | | | 0.1 | 0.2 | 0.1 | 0.1 | 0.1 |
| | E-1: Magnesium stearate | Parts by mass | 0.2 | 0.2 | 0.2 | 0.2 | 0.2 | 0.2 | 0.2 | 0.2 | 0.2 | 0.2 |
| | E-2: Pigment | Parts by mass | 1.5 | 1.5 | 1.5 | 1.5 | 1.5 | 1.5 | 1.5 | 1.5 | 1.5 | 1.5 |
| Extrusion discharge amount | | kg/hr | 350 | 450 | 350 | 350 | 450 | 350 | 450 | 350 | 450 | 350 |
| Com- | MFR (275° C., | g/10 min | 8.3 | 8.5 | 8.1 | 13.0 | 11.5 | 21.5 | 21.5 | 4.3 | 4.3 | 34.5 |
| position | load: 2.16 kg) | | | | | | | | | | | |
| charac- | Cooling crystallization | ° C. | 176 | 177 | 175 | 185 | 188 | 176 | 177 | 176 | 177 | 176 |
| teristics | temperature | | | | | | | | | | | |
| | Appearance of molded | Determination | ⊙ | ⊙ | ⊙ | ◯ | Δ | ⊙ | ⊙ | ⊙ | ⊙ | ⊙ |
| | article | (glossiness) | 98 | 98 | 98 | 95 | 91 | 98 | 98 | 98 | 98 | 99 |
| | Heat deformation | ° C. | 220 | 220 | 220 | 223 | 223 | 218 | 218 | 223 | 223 | 215 |
| | temperature | | | | | | | | | | | |
| | Flexural strength | MPa | 350 | 350 | 350 | 345 | 340 | 325 | 32.5 | 355 | 355 | 290 |
| | Flexural modulus | GPa | 17.0 | 17.0 | 17.0 | 16.5 | 16.0 | 15.0 | 15.0 | 17.5 | 17.5 | 13.5 |
| | Charpy impact strength | kJ/m² | 16 | 16 | 16 | 15.5 | 15 | 15 | 25 | 16.5 | 16.5 | 14 |

| | | | Examples | | | Comparative Examples | | | |
|---|---|---|---|---|---|---|---|---|---|
| | | Unit | 11 | 12 | 13 | 1 | 2 | 3 | 4 |
| Blending | A-1: Polyamide 6 | Parts by mass | 39 | 47 | 32 | 45 | 45 | 32 | 32 |
| com- | B-1: Polyamide MXD6 | Parts by mass | 16 | 18 | 13 | | | | |
| position | B-2: Polyamide PA6T6I | Parts by mass | | | | | | 13 | 13 |
| | C-1: Glass fiber | Parts by mass | 45 | 35 | 35 | 55 | 55 | 55 | 55 |
| | C-2: Talc | Parts by mass | | | 20 | | | | |
| | D-1: Sodium hypophosphite | Parts by mass | 0.1 | 0.1 | 0.1 | | 0.2 | 0.1 | 0.1 |
| | E-1: Magnesium stearate | Parts by mass | 0.2 | 0.2 | 0.2 | 0.2 | 0.2 | 0.2 | 0.2 |
| | E-2: Pigment | Parts by mass | 1.5 | 1.5 | 1.5 | 1.5 | 1.5 | 1.5 | 1.5 |
| Extrusion discharge amount | | kg/hr | 450 | 350 | 350 | 350 | 350 | 350 | 450 |
| Com- | MFR (275° C., | g/10 min | 34.5 | 42.9 | 17.0 | 14.5 | 14.5 | 13.5 | 14.0 |
| position | load: 2.16 kg) | | | | | | | | |
| charac- | Cooling crystallization | ° C. | 176 | 177 | 181 | 203 | 197 | 185 | 187 |
| teristics | temperature | | | | | | | | |
| | Appearance of molded | Determination | ⊙ | ⊙ | ◯ | X | X | ⊙ | ⊙ |
| | article | (glossiness) | 99 | 99 | 96 | 84 | 88 | 98 | 98 |
| | Heat deformation | ° C. | 215 | 210 | 215 | 225 | 225 | 195 | 195 |
| | temperature | | | | | | | | |
| | Flexural strength | MPa | 290 | 2.65 | 275 | 315 | 315 | 325 | 325 |
| | Flexural modulus | GPa | 13.5 | 11.0 | 14.0 | 14.0 | 14.0 | 15.1 | 14.9 |
| | Charpy impact strength | kJ/m² | 14 | 12.5 | 12 | 17 | 17 | 11 | 11 |

It is found that a molded article having high strength, high rigidity, good appearance, and excellent high temperature rigidity can be obtained from the resin composition of each Example. In particular, when the blending ratio of the inorganic reinforcing material (C) is 40 to 59 parts by mass, the balance between rigidity and molding appearance is excellent.

As in Examples 1 and 2 (6 and 7, 8 and 9, 10 and 11), when a predetermined amount of a metal hypophosphite is contained, the resin composition of the present invention has a small change in melt fluidity of the resin composition even when the discharge amount of an extruder greatly varies, and the obtained molded article has excellent appearance and excellent mechanical properties with stability.

Even in Examples 4 and 5 of systems not containing a metal hypophosphite, the influence of the discharge amount variation was relatively small by containing a polyamide MXD6 resin, and the appearance of the molded article was improved.

In Comparative Examples 1 and 2 not containing the polyamide MXD6 resin, the molded article appearance was significantly poor. In Comparative Examples 3 and 4 containing polyamide 6T6I which is an amorphous polyamide resin instead of the polyamide MXD6 resin, the molded article had excellent appearance, but the molded article had deteriorated rigidity, heat resistance, and mechanical physical properties and the like. In Comparative Examples 3 and 4, the change in the physical properties of the resin composition when the discharge amount of the extruder greatly varied was slightly larger than those in Examples 1 and 2.

### INDUSTRIAL APPLICABILITY

Since a polyamide resin composition of the present invention can stably provide a molded article which is less likely to be affected by variations in production conditions, and has high rigidity and good appearance, the polyamide resin composition is suitable as a molding material for parts and molded articles in fields of automobiles, electric and electronic parts, and household products and the like which are required to have high rigidity and good appearance.

1. A polyamide resin composition comprising 0 to 3 parts by mass of a metal hypophosphite (D) with respect to a total of 100 parts by mass of 20 to 60 parts by mass of an aliphatic polyamide resin (A), 5 to 20 parts by mass of a polyamide MXD6 resin (B), and 30 to 59 parts by mass of an inorganic reinforcing material (C), wherein the polyamide resin composition has an MFR of 3 to 60 g/10 min when measured under conditions of a load of 2.16 kg and 275° C.

2. The polyamide resin composition according to claim 1, wherein a cooling crystallization temperature of the polyamide resin composition is 160 to 190° C.

3. The polyamide resin composition according to claim 1, wherein 0.001 to 3 parts by mass of the metal hypophosphite (D) is contained with respect to the total of 100 parts by mass of (A), (B) and (C).

4. The polyamide resin composition according to claim 1, wherein 40 to 59 parts by mass of the inorganic reinforcing material (C) in the polyamide resin composition is contained with respect to the total of 100 parts by mass of (A), (B) and (C).

5. The polyamide resin composition according to claim 1, wherein the inorganic reinforcing material (C) is glass fiber.

6. The polyamide resin composition according to claim 1, wherein the polyamide resin composition has an MFR of 4 to 25 g/10 min when measured under conditions of a load of 2.16 kg and 275° C.
